(19) United States
(12) Patent Application Publication
(10) Pub. No.: US 2019/0033599 A1
(43) Pub. Date: Jan. 31, 2019

(54) SHORT-DISTANCE OPTICAL AMPLIFICATION MODULE, AMPLIFICATION METHOD AND AMPLIFICATION SYSTEM

(71) Applicant: SHENZHEN DLODLO NEW TECHNOLOGY CO., LTD., Shenzhen, Guangdong (CN)

(72) Inventors: Gang LI, Shenzhen, Guangdong (CN); Weiping TANG, Shenzhen, Guangdong (CN)

(21) Appl. No.: 16/073,306

(22) PCT Filed: Jan. 28, 2016
(86) PCT No.: PCT/CN2016/072528

§ 371 Date: Jul. 26, 2018

(51) Int. Cl. G02B 27/01; G02B 27/28; G02B 5/00; G02B 5/30

(52) U.S. Cl. CPC G02B 27/0172; G02B 27/28; G02B 2027/013; G02B 5/30; G02B 5/003

(57) ABSTRACT

Disclosed are a short-distance optical amplification module, an amplification method and an amplification system. The module comprises a first phase delay plate (2), an imaging lens (4), a second phase delay plate (5) and a reflective type polarizing plate (6), wherein the first phase delay plate (2) is arranged in a transmission path of an optical image having a first linear polarization direction, the imaging lens (4) is arranged in a transmission path of an optical image having an elliptical or circular polarization direction, and the second phase delay plate (5) is arranged on one side of a second optical surface of the imaging lens. A second linear polarization direction is orthogonal to the first linear polarization direction. By means of the first phase delay plate (2), the imaging lens (4), the second phase delay plate (5) and the reflective type polarizing plate (6), an optical image is reflected by the reflective type polarizing plate (6) on a transmission path, and then is amplified on the imaging lens (4). Thus, not only the optical image can meet the requirement of optical magnification, but also the second phase delay plate (5) and the reflective type polarizing plate (6) can be arranged to adhere to each other, thereby further reducing the size and volume of an optical module.

### FIELD OF THE INVENTION

The present invention relates to optical apparatuses, and in particular, to a short-distance optical amplification module, an amplification method and an amplification system.

### BACKGROUND OF THE INVENTION

In the structure of an optical amplification module of the prior art, in order to meet the imaging quality requirement of the optical amplification module, the module generally includes a plurality of optical devices. Because each optical device requires a certain mounting space, the optical amplification module consisted of the plurality of optical devices often has a large size and a large volume, which in particular cannot meet the display requirements on small space and high amplification of an intelligent virtual reality (VR) wearable device.

### SUMMARY OF THE INVENTION

Embodiments of the present invention provide a short-distance optical amplification module, an amplification method and an amplification system, thereby solving the problem of large structural size of the existing optical amplification module.

In order to solve the above technical problem, embodiments of the invention put forwards the technical solutions below:

A short-distance optical amplification module, comprising: a first phase delay plate, an imaging lens, a second phase delay plate and a reflective type polarizing plate, wherein:

the first phase delay plate is arranged in a transmission path of an optical image having a first linear polarization direction and is configured for converting the polarization direction of the optical image from the first linear polarization direction to an elliptical or circular polarization direction;

the imaging lens is arranged in a transmission path of an optical image having an elliptical or circular polarization direction, and the imaging lens has a first optical surface adjacent to the first phase delay plate and a second optical surface opposite to the first optical surface, the first optical surface being a transflective optical surface, and the imaging lens is configured for amplifying an optical image passing through the first optical surface;

the second phase delay plate is arranged on one side of the second optical surface of the imaging lens and is configured for converting the polarization direction of the optical image from the elliptical or circular polarization direction to a second linear polarization direction, wherein the second linear polarization direction is orthogonal to the first linear polarization direction; and

the reflective type polarizing plate is adhered to the second phase delay plate, and the reflective type polarizing plate has a transmission direction consistent with the first linear polarization direction;

wherein, the optical image successively passes through the first phase delay plate, the imaging lens, the second phase delay plate and the reflective type polarizing plate, the reflective type polarizing plate is configured for reflecting an optical image having a second linear polarization direction that is transmitted from the second phase delay plate, the imaging lens is configured for amplifying the optical image reflected by the reflective type polarizing plate, and the second phase delay plate is further configured for converting the polarization direction of the amplified optical image into a non-second linear polarization direction, thereby passing an optical image having the non-second linear polarization direction through the reflective type polarizing plate.

Preferably, the non-second linear polarization direction is the first linear polarization direction.

Preferably, the second phase delay plate is adhered to the second optical surface of the imaging lens.

Preferably, the module further comprises: an absorptive type polarizing plate;

The absorptive type polarizing plate is adhered to one side of the reflective type polarizing plate that faces away from the imaging lens, and the absorptive type polarizing plate has a transmission direction consistent with the reflective type polarizing plate.

Preferably, the module further comprises: an optical display screen, which is configured for generating an optical image having a first linear polarization direction and is adhered to the first phase delay plate.

A short-distance optical amplification module, comprising: a first phase delay plate, an imaging lens, a second phase delay plate and a reflective type polarizing plate, wherein:

the first phase delay plate is arranged in a transmission path of an optical image having a first linear polarization direction and is configured for converting the polarization direction of the optical image from the first linear polarization direction to an elliptical or circular polarization direction;

the imaging lens is arranged in a transmission path of an optical image having an elliptical or circular polarization direction, and the imaging lens has a first optical surface adjacent to the first phase delay plate and a second optical surface opposite to the first optical surface, the first optical surface being a transflective optical surface, and the imaging lens is configured for amplifying an optical image passing through the first optical surface;

the second phase delay plate is arranged on one side of the second optical surface of the imaging lens and is configured for converting the polarization direction of the optical image from the elliptical or circular polarization direction to the first linear polarization direction; and

the reflective type polarizing plate is adhered to the second phase delay plate, and the reflective type polarizing plate has a transmission direction orthogonal to the first linear polarization direction;

wherein, the optical image successively passes through the first phase delay plate, the imaging lens, the second phase delay plate and the reflective type polarizing plate, the reflective type polarizing plate is configured for reflecting an optical image having a first linear polarization direction that is transmitted from the second phase delay plate, the imaging lens is configured for amplifying the optical image reflected by the reflective type polarizing plate, and the second phase delay plate is further configured for converting the polarization direction of the amplified optical image into a non-first linear polarization direction, thereby passing the optical image having the non-first linear polarization direction through the reflective type polarizing plate.

A short-distance optical amplification method, comprising the steps of:

outputting an optical image having a first linear polarization direction along a transmission path, converting the polarization direction of the optical image from the first linear polarization direction to an elliptical or circular polarization direction, and transmissively amplifying the optical image via an imaging lens;

converting the polarization direction of the optical image from the elliptical or circular polarization direction to a second linear polarization direction, the second linear polarization direction being orthogonal to the first linear polarization direction;

reflecting the optical image having the second linear polarization direction by a reflective type polarizing plate, and converting the polarization direction of the optical image from the second linear polarization direction to an elliptical or circular polarization direction, wherein, the reflective type polarizing plate has a transmission direction consistent with the first linear polarization direction; and

reflecting and amplifying the reflected optical image having an elliptical or circular polarization direction via the imaging lens, converting the polarization direction of the amplified optical image from the elliptical or circular polarization direction to a non-second linear polarization direction, and passing the optical image having the non-second linear polarization direction through the reflective type polarizing plate.

A short-distance optical amplification method, comprising the steps of:

outputting an optical image having a first linear polarization direction along a transmission path, converting the polarization direction of the optical image from the first linear polarization direction to an elliptical or circular polarization direction, and transmissively amplifying the optical image via an imaging lens;

converting the polarization direction of the optical image from the elliptical or circular polarization direction to a first linear polarization direction;

reflecting the optical image having the first linear polarization direction via a reflective type polarizing plate, and converting the polarization direction of the optical image from the first linear polarization direction to an elliptical or circular polarization direction, wherein, the reflective type polarizing plate has a transmission direction orthogonal to the first linear polarization direction; and

reflecting and amplifying the reflected optical image having an elliptical or circular polarization direction via the imaging lens, converting the polarization direction of the amplified optical image from the elliptical or circular polarization direction to a non-first linear polarization direction, and passing the optical image having the non-first linear polarization direction through the reflective type polarizing plate.

A short-distance optical amplification system, comprising: an optical display screen configured for generating an optical image having a first linear polarization direction, and a short-distance optical amplification module, wherein, the short-distance optical amplification module comprises:

a first phase delay layer, which is arranged in a transmission path of an optical image having a first linear polarization direction and is configured for converting the polarization direction of the optical image from the first linear polarization direction to an elliptical or circular polarization direction;

an imaging lens layer, which is arranged in a transmission path of an optical image having an elliptical or circular polarization direction, wherein the imaging lens has a first optical surface adjacent to the first phase delay plate and a second optical surface opposite to the first optical surface, the first optical surface being a transflective optical surface; wherein the imaging lens layer is configured for amplifying an optical image passing through the first optical surface;

a second phase delay layer, which is arranged on one side of the second optical surface of the imaging lens and is configured for converting the polarization direction of the optical image from the elliptical or circular polarization direction to a second linear polarization direction, wherein the second linear polarization direction is orthogonal to the first linear polarization direction; and

a reflective type polarization layer, which is adhered to the second phase delay layer and has a transmission direction consistent with the first linear polarization direction;

wherein, the optical image successively passes through the first phase delay layer, the imaging lens layer, the second phase delay layer and the reflective type polarization layer, and the reflective type polarization layer is configured for reflecting an optical image having a second linear polarization direction that is transmitted from the second phase delay layer, the imaging lens layer is configured for reflecting and again amplifying the optical image reflected by the reflective type polarization layer, and the second phase delay layer is further configured for converting the polarization direction of the amplified optical image into a non-second linear polarization direction, thereby passing the optical image having the non-second linear polarization direction through the reflective type polarization layer.

A short-distance optical amplification system, comprising: an optical display screen configured for generating an optical image having a first linear polarization direction, and a short-distance optical amplification module, wherein, the short-distance optical amplification module comprises:

a first phase delay layer, which is arranged in a transmission path of an optical image having a first linear polarization direction and is configured for converting the polarization direction of the optical image from the first linear polarization direction to an elliptical or circular polarization direction;

an imaging lens layer, which is arranged in a transmission path of an optical image having an elliptical or circular polarization direction, wherein the imaging lens has a first optical surface adjacent to the first phase delay plate and a second optical surface opposite to the first optical surface, the first optical surface being a transflective optical surface; wherein the imaging lens layer is configured for amplifying an optical image passing through the first optical surface;

a second phase delay layer, which is arranged on one side of the second optical surface of the imaging lens and is configured for converting the polarization direction of the optical image from the elliptical or circular polarization direction to the first linear polarization direction; and

a reflective type polarization layer, which is adhered to the second phase delay layer and has a transmission direction orthogonal to the first linear polarization direction;

wherein, the optical image successively passes through the first phase delay layer, the imaging lens layer, the second phase delay layer and the reflective type polarization layer, and the reflective type polarization layer is configured for reflecting an optical image having a first linear polarization direction that is transmitted from the second phase delay layer, the imaging lens layer is configured for reflecting and again amplifying the optical image reflected by the reflective type polarization layer, and the second phase delay layer is further configured for converting the polarization direction of the amplified optical image into a non-first linear polarization direction, thereby passing the optical image having the non-first linear polarization direction through the reflective type polarization layer.

It may be seen from the above technical solutions that the invention has the beneficial effects below:

In the short-distance optical amplification module according to the invention, by the first phase delay plate, the imaging lens, the second phase delay plate and the reflective type polarizing plate, an optical image can be amplified on the imaging lens after being reflected by the reflective type polarizing plate on the transmission path. Not only the optical image can meet the requirement of optical magnification, but also the second phase delay plate and the reflective type polarizing plate can be arranged to adhere to each other, thereby further reducing the size and volume of an optical module.

In the short-distance optical amplification module according to the invention, the second phase delay plate and the imaging lens are arranged to adhere to each other. The distance between the second phase delay plate and the reflective polarizing plate can be reduced without affecting the optical path, and the size and volume of the short-distance optical amplification module can be further reduced.

In the short-distance optical amplification module according to the invention, one side of the imaging lens is the second optical surface, so that the second optical surface can be adhered to the second phase delay plate, and the second phase delay plate is in turn adhered to the reflective polarizing plate, thus the size and volume of the short-distance optical amplification module can be further reduced. Additionally, one side of the imaging lens is arranged as the second optical surface, so that the degree of chromatic dispersion of a polarized light when the imaging lens is the first optical surface is diminished, thereby improving the definition of the optical image. In comparison with the first optical surface, the mirror finishing process and process difficulty of the second optical surface will be lower, and the manufacturing cost will be small.

In the short-distance optical amplification module according to the invention, an absorptive type polarizing plate is further added on the outer side of the reflective polarizing plate. The absorptive type polarizing plate can absorb the light from the outside and prevent a reflection image of the outside from being seen, thereby preventing the ambient light from interfering the optical image. Additionally, the absorptive type polarizing plate, the reflection polarizing plate and the second phase delay plate are arranged to adhere to each other, and the optical display screen and the first phase delay plate are arranged to adhere to each other, thus the volume and size of the optical amplification module may be further reduced, and assembly may be simplified.

In the short-distance optical amplification method according to the invention, an optical image is transmissively amplified via the imaging lens and then reflected on the reflective type polarizing plate. When the reflected optical image passes through the imaging lens again, it is amplified on the first optical surface for the second time, and the polarization direction is converted from an elliptical or circular polarization direction into a non-second linear polarization direction. Finally, it enters the human eyes via the reflective type polarizing plate. By twice reflection of the optical image in the optical amplification module, not only the visual angle can be enlarged, but also the size and volume of the optical amplification module can be reduced.

In the short-distance optical amplification system according to the invention, the short-distance optical amplification module is a multilayer optical structure consisted of a first phase delay layer, an imaging lens layer, a second phase delay layer and a reflective type polarization layer. The size and volume of the optical amplification module are greatly reduced without affecting the optical imaging quality, the weight is reduced, and the comfortableness of wearing VR glasses employing the optical amplification component is improved.

### BRIEF DESCRIPTION OF THE DRAWINGS

In order to more clearly illustrate the technical solutions of the embodiments of the invention or of the prior art, the drawings needed in the description of the embodiments or the prior art will be briefly introduced below. Apparently, the drawings in the description below are only some embodiments of the invention, and other drawings may also be obtained by one of ordinary skills in the art according to these drawings without creative work.

FIG. 1 is a structural representation of a short-distance optical amplification module according to an embodiment of the invention;

FIG. 2 is a structural representation of another short-distance optical amplification module according to an embodiment of the invention;

FIG. 3 is a schematic diagram showing the transmission of an optical image in a first optical surface and a second optical surface of an imaging lens respectively;

FIG. 4 is a structural representation of yet another short-distance optical amplification module according to an embodiment of the invention;

FIG. 5 is a structural representation of still another short-distance optical amplification module according to an embodiment of the invention;

FIG. 6 is a flow chart of a short-distance optical amplification method according to an embodiment of the invention;

FIG. 7 is a flow chart of another short-distance optical amplification method according to an embodiment of the invention;

FIG. 8 is a structural representation of a short-distance optical amplification system according to an embodiment of the invention; and

FIG. 9 is a structural representation of another short-distance optical amplification system according to an embodiment of the invention.

### DETAILED DESCRIPTION OF THE EMBODIMENTS

For one skilled in the art to better understand the technical solutions of the invention, the technical solutions in the embodiments of the invention will be described clearly and fully below in conjunction with the drawings in the embodiments of the invention.

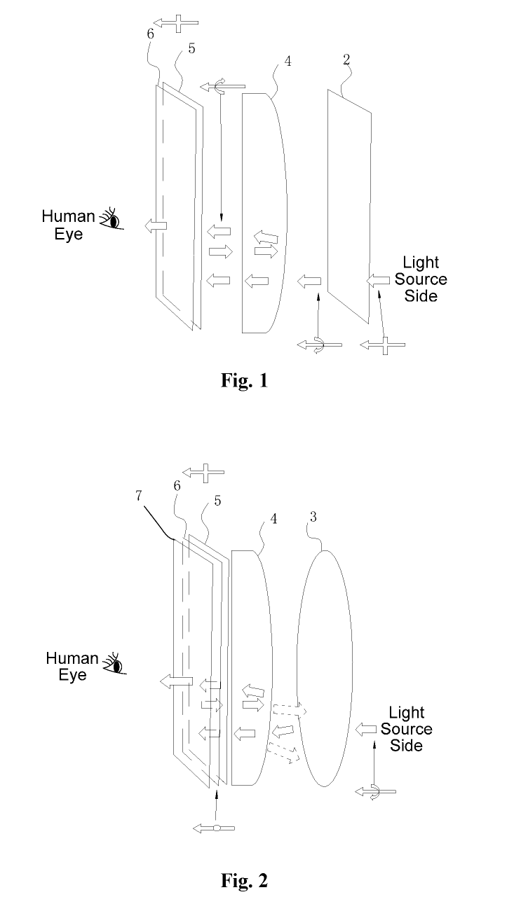

A short-distance optical amplification module, as shown in FIG. 1, includes a first phase delay plate 2, an imaging lens 4, a second phase delay plate 5 and a reflective type polarizing plate 6 that are successively arranged, wherein, the first phase delay plate 2 is arranged in a transmission path of an optical image having a first linear polarization direction and is configured for converting the polarization direction of the optical image from the first linear polarization direction to an elliptical or circular polarization direction. The optical image refers to the light or polarized light emitted from the light source side.

The imaging lens 2 is arranged in a transmission path of an optical image having an elliptical or circular polarization direction. The imaging lens 2 has a first optical surface adjacent to the first phase delay plate and a second optical surface opposite to the first optical surface, the first optical surface being a transflective optical surface, and the imaging lens is configured for amplifying an optical image passing through the first optical surface, said amplification is referred to as first-time amplification.

Wherein, in this embodiment, the first optical surface is a curved surface, the second optical surface is a flat surface, and the center of curvature of the first optical surface and the second optical surface are located on the same side of the first optical surface.

The second phase delay plate 5 is arranged on one side of the second optical surface of the imaging lens 4 and is configured for converting the polarization direction of the optical image from the elliptical or circular polarization direction to a second linear polarization direction. Moreover, the second linear polarization direction is orthogonal to the first linear polarization direction.

The reflective type polarizing plate 6 is adhered to the second phase delay plate 5, and the reflective type polarizing plate 6 has a transmission direction consistent with the first linear polarization direction.

Wherein, the optical image successively passes through the first phase delay plate 2, the imaging lens 4, the second phase delay plate 5 and the reflective type polarizing plate 6. Moreover, the reflective type polarizing plate 6 is further configured for reflecting an optical image having a second linear polarization direction that is transmitted from the second phase delay plate 5, and the imaging lens 4 is configured for amplifying the optical image reflected by the reflective type polarizing plate 6, wherein said amplification is referred to as second-time amplification. The second phase delay plate 5 is further configured for converting the polarization direction of the second-time amplified optical image into a non-second linear polarization direction, thereby passing an optical image having the non-second linear polarization direction through the reflective type polarizing plate 6.

Wherein, the non-second linear polarization direction is preferably the first linear polarization direction.

The first phase delay plate 2, the second phase delay plate 5 and reflective polarizing plate 6 in this embodiment all belong to the prior art. Each time an optical image passes through a phase delay plate, a certain degree of phase delay can be added. A reflective polarizing plate can transmit a linearly-polarized light with a polarization direction consistent with the transmission direction thereof, but totally reflect a linearly-polarized light with a polarization direction orthogonal to the transmission direction thereof, and partially transmit a circularly-polarized light or an elliptically-polarized light with a certain phase delay. In the two sides of the imaging lens 4, the side adjacent to the first phase delay plate 2 is the first optical surface, and the side adjacent to the second phase delay plate 5 is the second optical surface, wherein the first optical surface is a transflective optical surface, by which a certain ratio of light may be reflected, and the remaining ratio of light may be transmitted.

The operational principle of the short-distance optical amplification module according to the invention will be introduced below.

On the side adjacent to the light source (the rightmost side in FIG. 1), after an optical image having a first linear polarization direction (in this embodiment, the direction parallel to paper direction) passes through the first phase delay plate 2, the polarization direction of the optical image is changed to a phase-delayed elliptical polarization direction or circular polarization direction. Especially, when the first phase delay plate 2 is a ¼ wave plate, the polarization direction of the optical image transmitted will be changed to a circular polarization direction after passing through the first phase delay plate 2, and then it will be transmitted when passing through the first optical surface of the imaging lens, so that the optical image will be transmissively amplified. This amplification is a small amplification. The polarization direction of the optical image transmitted will be converted from the elliptical or circular polarization direction to a second linear polarization direction (in this embodiment, vertical to the paper direction) after passing through the second phase delay plate 5. The second linear polarization direction is orthogonal to the first linear polarization direction. In this embodiment, the direction of a polarized light rotated by the first phase delay plate 2 is consistent with that rotated by the second phase delay plate 5 (that is, the first phase delay plate 2 and the second phase delay plate 5 are both left-handed or right-handed phase delay plates).

After reaching the reflective type polarizing plate 6, the optical image having a second linear polarization direction will be totally reflected. After the reflected optical image passes through the second phase delay plate 5 again, the polarization direction will be converted from the first linear polarization direction to an elliptical or circular polarization direction. Especially, when the second phase delay plate 5 is a ¼ wave plate, after passing through the second phase delay plate 5, the polarization direction of the reflected optical image will be changed to a circular polarization direction.

Light will be reflected and amplified with a certain ratio of energy when the optical image again passes through the first optical surface of the imaging lens 4 and is reflected, and this amplification is a large amplification. The optical image largely amplified passes through the second phase delay plate 5 again, and the polarization direction thereof is changed to a non-second linear polarization direction (preferably, the first linear polarization direction). Especially, when the first phase delay plate 2 is a ¼ wave plate, the polarization direction of the optical image is changed to the first linear polarization direction after passing through the first phase delay plate 2 again. Because the reflective type polarizing plate 6 has a transmission direction consistent with the first linear polarization direction, the optical image having a first linear polarization direction will enter the sight of a viewer via the reflective polarizing plate 6, so that large amplification of light may be realized in a short distance (less than 5 cm).

In the short-distance optical amplification module according to the embodiment of the invention, by the first phase delay plate, the imaging lens, the second phase delay plate and the reflective type polarizing plate, an optical image can be amplified on the imaging lens after being reflected by the reflective type polarizing plate on the transmission path. Not only the optical image can meet the requirement of optical magnification, but also the second phase delay plate and the reflective type polarizing plate can be arranged to adhere to each other, thereby further reducing the size and volume of an optical module.

In one preferred embodiment, the non-second linear polarization direction is the first linear polarization direction, so that the polarization direction of the optical image is changed to the first linear polarization direction again after passing through the second phase delay plate so as to guarantee that the optical image is totally reflected when reaching the reflective type polarizing plate for the first time. That is, at this moment, the polarization direction of the optical image is changed to a second linear polarization direction that is orthogonal to the first linear polarization direction, and the optical path difference of the optical image after passing through the first phase delay plate 2 and the second phase delay plate 4 is ½,1½,2½ . . . n½, wherein n is an integer.

Additionally, the second phase delay plate 5 and the reflective polarizing plate 6 can be arranged to adhere to each other, thus the transmission path of the polarized light in the second phase delay plate 5 and the reflective polarizing plate 6 can be reduced. The distance between the second phase delay plate and the reflective polarizing plate can be reduced without affecting the optical path, and hence the size and volume of the short-distance optical amplification module can be further reduced.

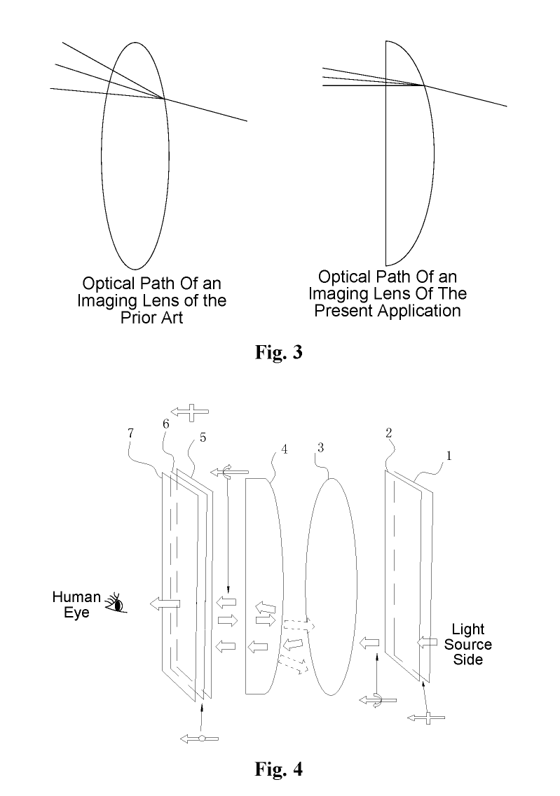

As shown in FIG. 2, in order to further reduce the size and volume of the optical amplification component, the second phase delay plate is adhered to the second optical surface of the imaging lens. The side of the imaging lens 4 (transflective curved lens 4) that is adjacent to the second phase delay plate 5 is provided as the second optical surface, and the flat surface can be adhered to the second phase delay plate 5. Generally, the mirror surface of the imaging lens 4 is a circular arc camber. In this embodiment, the side of the imaging lens 4 adjacent to the second phase delay plate 5 is provided as a flat surface. On one hand, it may be realized that the second phase delay plate 5 and the imaging lens 4 are adhered to each other, the distance between the two optical components is further shortened, and the size of the optical amplification module is reduced. On the other hand, as shown in FIG. 3, if the two sides of the imaging lens 4 are both curved surfaces, a too large curved surface will cause chromatic dispersion to the light, and hence the visual imaging effect will be affected; or, if the curvature of the curved surface is small, the optical path will be reduced, and the amplification effect will be affected. Therefore, by providing one side of the imaging lens 4 according to this embodiment as a flat surface, the degree of chromatic dispersion on the curved surface can be reduced, or the problem of small amplification on the optical path caused by a small curvature may be alleviated, thus the refraction or reflection of light in the optical module can be made more stable, and the imaging effect of the optical path will not be affected.

Additionally, for the production process, one side of the transflective curved lens according to this embodiment is a flat surface, and in comparison with the existing imaging lens of which the two sides are both curved surfaces, the manufacture difficulty of a flat surface is lower than that of a curved surface, and correspondingly, the manufacturing cost is also reduced, and hence the production efficiency can be improved.

As shown in FIG. 2, the short-distance optical amplification module according to this solution further includes an absorptive type polarizing plate 7, wherein, the absorptive type polarizing plate 7 is arranged on one side of the reflective polarizing plate 6 that faces away from the imaging lens 4. Additionally, the absorptive type polarizing plate 7 may be adhered to the reflective polarizing plate 6, and the transmission direction of the absorptive type polarizing plate 7 is consistent with (parallel to) that of the absorptive type polarizing plate 7.

In the short-distance optical amplification module according to the invention, an absorptive type polarizing plate is added on the outer side of the reflective polarizing plate, and the transmission direction of the absorptive type polarizing plate is arranged parallel to that of the reflection polarizing plate. That is, a polarized light emitted from the reflection polarizing plate may directly pass through the absorptive type polarizing plate. The ambient light is absorbed by the absorptive type polarizing plate. Therefore, a reflection image of the outside may be prevented from being seen, and the interference to display by the outside light is prevented. Additionally, by adhering the reflection polarizing plate and the second phase delay plate to each other, light loss may be lowered, the volume and size may be further reduced, and assembly may be simplified.

When the above short-distance optical amplification module according to the invention is applied to a VR device, for example, VR glasses:

As shown in FIG. 4, the short-distance optical amplification module further includes an optical display screen 1. The optical display screen 1 is arranged on one side of the first phase delay plate 2 that faces away from the transflective curved lens 4 and is configured for generating an optical image having a first linear polarization direction. Moreover, the optical display screen is adhered to the first phase delay plate 2.

For the short-distance optical amplification module in this embodiment, because the optical display screen 1 is adhered to the first phase delay plate 2 and the second phase delay plate 5 is adhered to the reflective polarizing plate 6, two sets of distances are reduced respectively. When a part of the components in the optical module are adhered to each other without affecting the transmission of the optical path, the size of the optical module can be greatly reduced. When the short-distance optical amplification module is applied to VR glasses, the size and thickness of the VR glasses can be reduced, and the volume can be decreased, thus it may approach the size of ordinary glasses, and the comfortableness of a user wearing the VR glasses may be improved.

The first optical surface of the above imaging lens 4 is a transflective optical surface, that is, a 50% transmissive and 50% reflective optical surface. The optical display screen 1 may be a minitype high-resolution display screen. In the case that a minitype high-resolution display screen is selected, a display effect of large visual field and high resolution may be realized with a small volume.

In the short-distance optical amplification module according to the invention, the second phase delay plate 5, the reflective polarizing plate 6 and the absorptive type polarizing plate are arranged to adhere to each other successively, and the optical display screen 1 and the first phase delay plate 2 are also arranged to adhere to each other. As a result, in comparison with a short-distance optical amplification module before adherence, the size and volume of a short-distance optical amplification module after adherence may be greatly reduced. Additionally, the absorptive type polarizing plate added can absorb the light from the outside and prevent a reflection image of the outside from being seen, thereby preventing the interference of the ambient light on the display.

Additionally, in the optical amplification module, an optical device 3 that will not affect the phase delay of the light may be added as required between any adjacent two of the optical display screen 1, the first phase delay plate 2, the imaging lens 4, the second phase delay plate 5 and the reflective polarizing plate 6. Preferably, as shown in FIG. 4, an optical module 3 for correcting hue change may be added between the first phase delay plate 2 and the imaging lens 4 to strengthen the utility of the short-distance optical amplification module.

In order to make human eyes see an image at the axial center of the reflective polarizing plate 6, the optical display screen 1, the first phase delay plate 2, the imaging lens 4, the second phase delay plate 5, the reflective polarizing plate 6 and the absorptive type polarizing plate 7 are arranged coaxially.

The axial side of the short-distance optical amplification module according to the invention is wrapped with a light-absorbing material, which can absorb the light that is not finally transmitted through the reflective polarizing plate and enters the human eyes and can prevent such light from affecting the final display result.

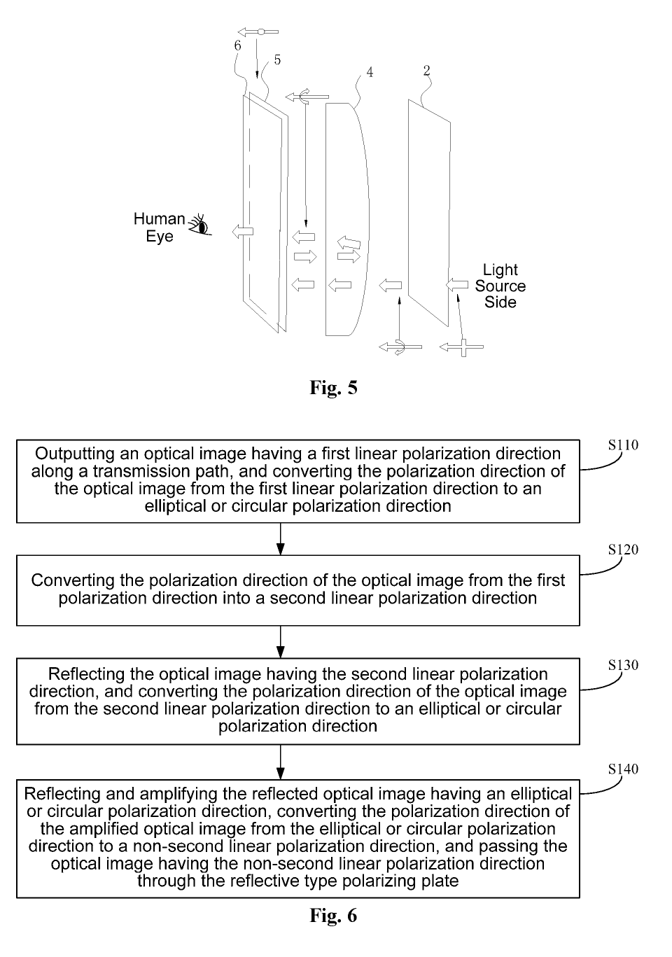

Referring to FIG. 5, in comparison with the above embodiment, this embodiment differs in that: in this embodiment, the direction of a polarized light rotated by the first phase delay plate 2 is opposite to that rotated by the second phase delay plate 5; that is, if the first phase delay plate 2 has a left-handed rotation direction, the second phase delay plate 5 will have a right-handed rotation direction; or, if the first phase delay plate 2 has a right-handed rotation direction, the second phase delay plate 5 will have a left-handed rotation direction. Correspondingly, in this embodiment, the reflective type polarizing plate 5 has a transmission direction orthogonal to the first linear polarization direction; the second phase delay plate 2 is arranged on one side of the second optical surface of the imaging lens 4 and configured for converting the polarization direction of the optical image from the elliptical or circular polarization direction to the first linear polarization direction.

The optical image successively passes through the first phase delay plate 2, the imaging lens 4, the second phase delay plate 5 and the reflective type polarizing plate 6. Moreover, the reflective type polarizing plate 6 is further configured for reflecting the optical image having a first linear polarization direction that is transmitted from the second phase delay plate 5, and the imaging lens 4 is configured for amplifying the optical image reflected by the reflective type polarizing plate 6, said amplification is referred to as second-time amplification. The second phase delay plate 5 is further configured for converting the polarization direction of the second-time amplified optical image into a non-first linear polarization direction, thereby passing the optical image having the non-first linear polarization direction through the reflective type polarizing plate 6.

The non-first linear polarization direction is preferably a direction orthogonal to the first linear polarization direction.

As shown in FIG. 6, corresponding to the above short-distance optical amplification module, the invention further provides a short-distance optical amplification method, and the method includes the following steps.

Step S110: an optical image having a first linear polarization direction is output along a transmission path, the polarization direction of the optical image is converted from the first linear polarization direction to an elliptical or circular polarization direction, and the optical image is transmissively amplified via an imaging lens.

Step S120: the polarization direction of the optical image is converted from the elliptical or circular polarization direction to a second linear polarization direction, the second linear polarization direction being orthogonal to the first linear polarization direction.

Step S130: the optical image having the second linear polarization direction is reflected by a reflective type polarizing plate, and the polarization direction of the optical image is converted from the second linear polarization direction to an elliptical or circular polarization direction, wherein, the reflective type polarizing plate has a transmission direction consistent with the first linear polarization direction.

Step S140: the reflected optical image having an elliptical or circular polarization direction is reflectively amplified via the imaging lens, the polarization direction of the amplified optical image is converted from the elliptical or circular polarization direction to a non-second linear polarization direction, and the optical image having the non-second linear polarization direction is passed through the reflective type polarizing plate.

In the short-distance optical amplification method according to the invention, based on the amplification principle of the above short-distance optical amplification module, very large amplification is combined in a small overall optical channel by making full use of the large angle (relative to the small angle variation of transmission) adjustment feature of a reflective optical module, thus a large visual angle effect can be realized for a minitype screen. Considering the low sensitivity on the overall brightness loss in near eye optics, a mode of discarding a part of the energy of an imaging lens is employed in the overall optical design in the invention, without apparently affecting the final display effect. Therefore, a near eye display optical module with high amplification, small overall thickness and almost no phase difference is realized in the invention.

In the short-distance optical amplification method according to the invention, an optical image is transmissively amplified via the imaging lens and then reflected on the reflective type polarizing plate. When the reflected optical image passes through the imaging lens again, it is amplified on the first optical surface for the second time, and the polarization direction is converted from an elliptical or circular polarization direction into a non-second linear polarization direction, and finally, it enters the human eyes via the reflective type polarizing plate. By twice reflection of the optical image in the optical amplification module, not only the visual angle can be enlarged, but also the size and volume of the optical amplification module can be reduced.

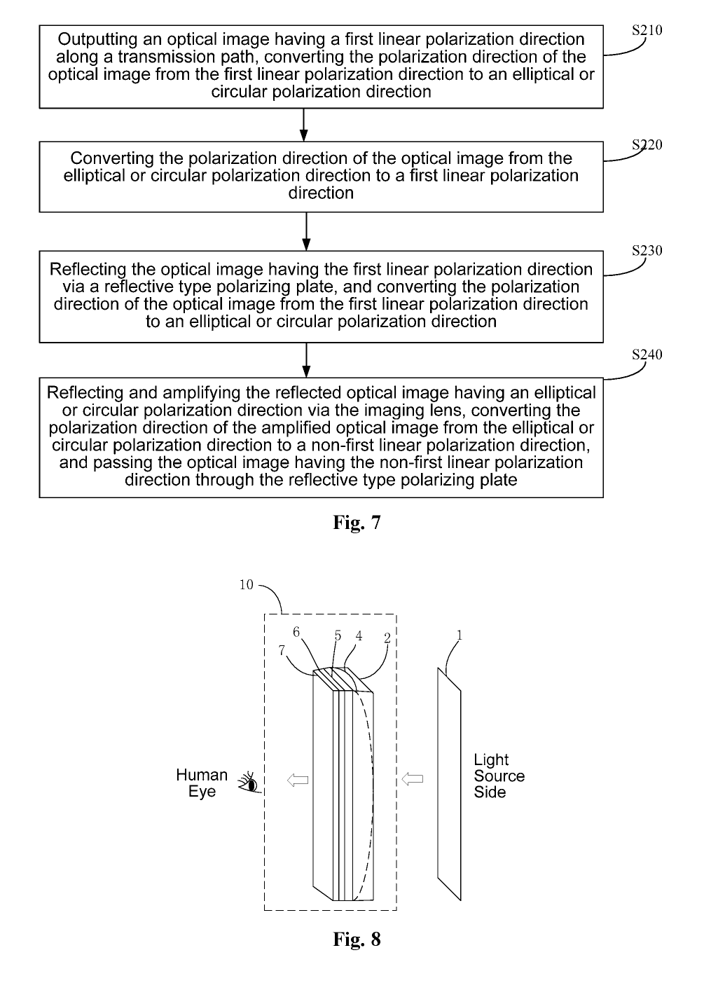

As shown in FIG. 7, the invention further provides a short-distance optical amplification method, and the method includes the following steps.

Step S210: an optical image having a first linear polarization direction is output along a transmission path, the polarization direction of the optical image is converted from the first linear polarization direction to an elliptical or circular polarization direction, and the optical image is transmissively amplified via an imaging lens.

Step S220: the polarization direction of the optical image is converted from the elliptical or circular polarization direction to a first linear polarization direction.

Step S230: the optical image having the first linear polarization direction is reflected via a reflective type polarizing plate, and the polarization direction of the optical image is converted from the first linear polarization direction to an elliptical or circular polarization direction, wherein, the reflective type polarizing plate has a transmission direction orthogonal to the first linear polarization direction.

Step S240: the reflected optical image having an elliptical or circular polarization direction is reflectively amplified via the imaging lens, the polarization direction of the amplified optical image is converted from the elliptical or circular polarization direction to a non-first linear polarization direction, and the optical image having the non-first linear polarization direction is passed through the reflective type polarizing plate.

The invention further provides a short-distance optical amplification system. As shown in FIG. 8, the system includes an optical display screen 1 configured for generating an optical image having a first linear polarization direction, and a short-distance optical amplification module 10, wherein, the short-distance optical amplification module 10 includes: a first phase delay layer 2, an imaging lens layer 4, a second phase delay layer 5 and a reflective type polarization layer 6, wherein:

the first phase delay layer 2 is arranged in a transmission path of an optical image having a first linear polarization direction and is configured for converting the polarization direction of the optical image from the first linear polarization direction to an elliptical or circular polarization direction;

the imaging lens layer 4 is arranged in a transmission path of an optical image having an elliptical or circular polarization direction and has a first optical surface adjacent to the first phase delay plate 2 and a second optical surface opposite to the first optical surface, the first optical surface being a transflective optical surface, and the imaging lens 4 is configured for amplifying an optical image passing through the first optical surface;

the second phase delay layer 5 is arranged on one side of the second optical surface of the imaging lens 4 and is configured for converting the polarization direction of the optical image from the elliptical or circular polarization direction to a second linear polarization direction, wherein the second linear polarization direction is orthogonal to the first linear polarization direction;

the reflective type polarization layer 6 is adhered to the second phase delay layer 5, and the reflective type polarization layer 6 has a transmission direction consistent with the first linear polarization direction.

The optical display screen 1 is arranged on one side of the first phase delay layer 2 that is adjacent to the short-distance optical amplification module 10.

The optical image successively passes through the first phase delay layer, the imaging lens layer, the second phase delay layer and the reflective type polarization layer. The reflective type polarization layer is configured for reflecting an optical image having a second linear polarization direction that is transmitted from the second phase delay layer. The imaging lens layer is configured for reflecting and again amplifying the optical image reflected by the reflective type polarization layer. The second phase delay layer is further configured for converting the polarization direction of the amplified optical image into a non-second linear polarization direction, thereby passing an optical image having the non-second linear polarization direction through the reflective type polarizing plate.

The structural positions and functions of the first phase delay layer, the imaging lens layer, the second phase delay layer and the reflective type polarization layer in the short-distance optical amplification system according to this embodiment are respectively the same as the structural positions and functions of the first phase delay layer, the imaging lens layer, the second phase delay layer and the reflective type polarization layer in the above example, and the transmission process of the optical image in the short-distance optical amplification module 10 is also the same as that in the above short-distance optical amplification module. The difference lies in that: in this embodiment, the short-distance optical amplification module is a multilayer optical structure consisted of a first phase delay layer, an imaging lens layer, a second phase delay layer and a reflective type polarization layer, and the size and volume of the optical amplification module are greatly reduced without affecting the optical imaging quality, the weight is reduced, and the comfortableness of wearing VR glasses employing the optical amplification component is improved.

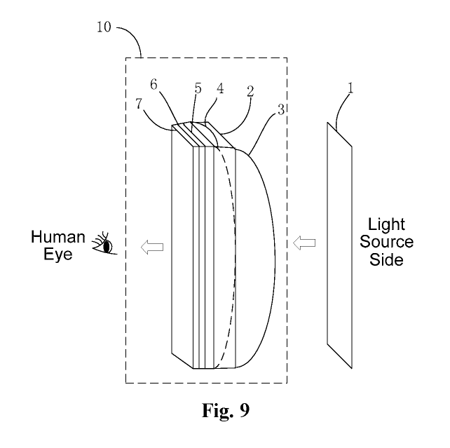

Additionally, as shown in FIG. 8 or 9, the short-distance optical amplification module 10 in the optical amplification system further includes an absorptive type polarization layer 7, wherein, the absorptive type polarization layer 7 is arranged on one side that is adjacent to the reflective polarization layer 6 and faces away from the second phase delay layer 5, and the absorptive type polarization layer can absorb the light from the outside and prevent a reflection image of the outside from being seen, thereby preventing the interference of the ambient light on the display.

In one preferred embodiment, the system further includes an optical device 3 that will not affect the phase delay, wherein, the optical device 3 is arranged between any two of the optical display screen, the first phase delay layer, the imaging lens layer, the second phase delay layer and the reflective polarization layer.

As shown in FIG. 9, the optical device 3 that will not affect the phase delay is arranged between the first phase delay layer 2 and the optical display screen 1 and is integrated with the short-distance optical amplification module 10. Preferably, the optical device includes a near-sighted lens, a far-sighted lens or an astigmatic lens, thereby improving the applicability of the short-distance optical amplification module.

In the above embodiment, the two sides of the optical display screen 1 are both flat surfaces. In order to reduce the size and volume of the module, the first phase delay plate 2 is adhered to the optical display screen 1. Moreover, the first phase delay plate and the second phase delay plate are both ¼ wave plates.

Additionally, the invention further provides a short-distance optical amplification system. The system includes an optical display screen 1 configured for generating an optical image having a first linear polarization direction and a short-distance optical amplification module 10, wherein, the short-distance optical amplification module 10 includes:

a first phase delay layer 2, which is arranged in a transmission path of an optical image having a first linear polarization direction and configured for converting the polarization direction of the optical image from the first linear polarization direction to an elliptical or circular polarization direction;

an imaging lens layer 4, which is arranged in a transmission path of an optical image having an elliptical or circular polarization direction and is configured for amplifying an optical image passing through the first optical surface, wherein the imaging lens has a first optical surface adjacent to the first phase delay plate and a second optical surface opposite to the first optical surface, the first optical surface being a transflective optical surface;

a second phase delay layer 5, which is arranged one side of the second optical surface of the imaging lens layer 4 and is configured for converting the polarization direction of the optical image from the elliptical or circular polarization direction to the first linear polarization direction;

a reflective type polarization layer 6, which is adhered to the second phase delay layer 5 and has a transmission direction orthogonal to the first linear polarization direction;

wherein, the optical image successively passes through the first phase delay layer 2, the imaging lens layer 4, the second phase delay layer 5 and the reflective type polarization layer 6, and the reflective type polarization layer 6 is configured for reflecting the optical image having a first linear polarization direction that is transmitted from the second phase delay layer 5, the imaging lens layer 4 is configured for reflecting and again amplifying the optical image reflected by the reflective type polarization layer 6, and the second phase delay layer 5 is further configured for converting the polarization direction of the amplified optical image into a non-first linear polarization direction, thereby passing the optical image having the non-first linear polarization direction through the reflective type polarization layer 6.

In the above embodiment, the first optical surface is a curved surface, the second optical surface is a flat surface, and the center of curvature of the first optical surface and the second optical surface are located on the same side of the first optical surface.

It should be noted that, relational terms such as “first” and “second” employed herein are only used for distinguishing one entity or operation from another entity or operation, rather than requiring or implying that these entities or operations have such a practical relation or sequence.

The above description only shows some specific embodiments of the invention for one skilled in the art to understand or implement the invention. Various modifications to these embodiments are apparent to those skilled in the art. The general principles defined herein may be implemented in other embodiments without departing from the spirit or scope of the invention. Therefore, the invention will not be limited to the embodiments described herein; instead, the invention conforms to the widest scope that is consistent with the principles and novel features disclosed herein.

1. A short-distance optical amplification module, comprising: a first phase delay plate, an imaging lens, a second phase delay plate and a reflective type polarizing plate, wherein:
the first phase delay plate is arranged in a transmission path of an optical image having a first linear polarization direction and is configured for converting the polarization direction of the optical image from the first linear polarization direction to an elliptical or circular polarization direction;
the imaging lens is arranged in a transmission path of an optical image having an elliptical or circular polarization direction, and the imaging lens has a first optical surface adjacent to the first phase delay plate and a second optical surface opposite to the first optical surface, the first optical surface is a transflective optical surface, and the imaging lens is configured for amplifying an optical image passing through the first optical surface;
the second phase delay plate is arranged on one side of the second optical surface of the imaging lens and is configured for converting the polarization direction of the optical image from the elliptical or circular polarization direction to a second linear polarization direction, wherein the second linear polarization direction is orthogonal to the first linear polarization direction;
the reflective type polarizing plate is adhered to the second phase delay plate, and the reflective type polarizing plate has a transmission direction consistent with the first linear polarization direction;
wherein, the optical image successively passes through the first phase delay plate, the imaging lens, the second phase delay plate and the reflective type polarizing plate, the reflective type polarizing plate is configured for reflecting an optical image having a second linear polarization direction that is transmitted from the second phase delay plate, the imaging lens is configured for amplifying the optical image reflected by the reflective type polarizing plate, and the second phase delay plate is further configured for converting the polarization direction of the amplified optical image into a non-second linear polarization direction, thereby passing an optical image having the non-second linear polarization direction through the reflective type polarizing plate.

2. The module according to claim 1, wherein, the non-second linear polarization direction is the first linear polarization direction.

3. The module according to claim 1, wherein, the second phase delay plate is adhered to the second optical surface of the imaging lens.

4. The module according to claim 2, further comprising: an absorptive type polarizing plate;
the absorptive type polarizing plate is adhered to one side of the reflective type polarizing plate that faces away from the imaging lens, and the absorptive type polarizing plate has a transmission direction consistent with the reflective type polarizing plate.

5. The module according to claim 1, further comprising: an optical display screen, which is configured for generating an optical image having the first linear polarization direction and is adhered to the first phase delay plate.

6. A short-distance optical amplification module, comprising: a first phase delay plate, an imaging lens, a second phase delay plate and a reflective type polarizing plate, wherein:
the first phase delay plate is arranged in a transmission path of an optical image having a first linear polarization direction and is configured for converting the polarization direction of the optical image from the first linear polarization direction to an elliptical or circular polarization direction;
the imaging lens is arranged in a transmission path of an optical image having an elliptical or circular polarization direction, and the imaging lens has a first optical surface adjacent to the first phase delay plate and a second optical surface opposite to the first optical surface, the first optical surface is a transflective optical surface, and the imaging lens is configured for amplifying an optical image passing through the first optical surface;
the second phase delay plate is arranged on one side of the second optical surface of the imaging lens and is configured for converting the polarization direction of the optical image from the elliptical or circular polarization direction to the first linear polarization direction; the reflective type polarizing plate is adhered to the second phase delay plate, and the reflective type polarizing plate has a transmission direction orthogonal to the first linear polarization direction;
wherein, the optical image successively passes through the first phase delay plate, the imaging lens, the second phase delay plate and the reflective type polarizing plate, the reflective type polarizing plate is configured for reflecting an optical image having a first linear polarization direction that is transmitted from the second phase delay plate, the imaging lens is configured for amplifying the optical image reflected by the reflective type polarizing plate, and the second phase delay plate is further configured for converting the polarization direction of the amplified optical image into a non-first linear polarization direction, thereby passing the optical image having the non-first linear polarization direction through the reflective type polarizing plate.

7. A short-distance optical amplification method, comprising the steps of:
outputting an optical image having a first linear polarization direction along a transmission path, converting the polarization direction of the optical image from the first linear polarization direction to an elliptical or circular polarization direction, and transmitting and amplifying the optical image via an imaging lens;
converting the polarization direction of the optical image from the elliptical or circular polarization direction to a second linear polarization direction, the second linear polarization direction being orthogonal to the first linear polarization direction;
reflecting the optical image having the second linear polarization direction by a reflective type polarizing plate, and converting the polarization direction of the optical image from the second linear polarization direction to an elliptical or circular polarization direction, wherein, the reflective type polarizing plate has a transmission direction consistent with the first linear polarization direction;
reflecting and amplifying the reflected optical image having an elliptical or circular polarization direction via the imaging lens, and converting the polarization direction of the amplified optical image from the elliptical or circular polarization direction to a non-second linear polarization direction, and passing the optical image having the non-second linear polarization direction through the reflective type polarizing plate.

8. A short-distance optical amplification method, comprising the steps of:
outputting an optical image having a first linear polarization direction along a transmission path, converting the polarization direction of the optical image from the first linear polarization direction to an elliptical or circular polarization direction, and transmitting and amplifying the optical image via an imaging lens;
converting the polarization direction of the optical image from the elliptical or circular polarization direction to a first linear polarization direction;
reflecting the optical image having the first linear polarization direction via a reflective type polarizing plate, and converting the polarization direction of the optical image from the first linear polarization direction to an elliptical or circular polarization direction, wherein, the reflective type polarizing plate has a transmission direction orthogonal to the first linear polarization direction; and
reflecting and amplifying the reflected optical image having an elliptical or circular polarization direction via the imaging lens, converting the polarization direction of the amplified optical image from the elliptical or circular polarization direction to a non-first linear polarization direction, and passing the optical image having the non-first linear polarization direction through the reflective type polarizing plate.

9. A short-distance optical amplification system, comprising: an optical display screen configured for generating an optical image having a first linear polarization direction, and a short-distance optical amplification module, wherein, the short-distance optical amplification module comprises:
a first phase delay layer, which is arranged in a transmission path of an optical image having a first linear polarization direction and is configured for converting the polarization direction of the optical image from the first linear polarization direction to an elliptical or circular polarization direction;
an imaging lens layer, which is arranged in a transmission path of an optical image having an elliptical or circular polarization direction, wherein the imaging lens has a first optical surface adjacent to the first phase delay plate and a second optical surface opposite to the first optical surface, the first optical surface being a transflective optical surface; wherein the imaging lens is configured for amplifying an optical image passing through the first optical surface;
a second phase delay layer, which is arranged on one side of the second optical surface of the imaging lens and is configured for converting the polarization direction of the optical image from the elliptical or circular polarization direction to a second linear polarization direction, wherein the second linear polarization direction is orthogonal to the first linear polarization direction; and
a reflective type polarization layer, which is adhered to the second phase delay layer and has a transmission direction consistent with the first linear polarization direction;
wherein, the optical image successively passes through the first phase delay layer, the imaging lens layer, the second phase delay layer and the reflective type polarization layer, and the reflective type polarization layer is configured for reflecting an optical image having a second linear polarization direction that is transmitted from the second phase delay layer, the imaging lens layer is configured for reflecting and again amplifying the optical image reflected by the reflective type polarization layer, and the second phase delay layer is further configured for converting the polarization direction of the amplified optical image into a non-second linear polarization direction, thereby passing the optical image having the non-second linear polarization direction through the reflective type polarization layer.

10. A short-distance optical amplification system, comprising: an optical display screen configured for generating an optical image having a first linear polarization direction, and a short-distance optical amplification module, wherein, the short-distance optical amplification module comprises:
a first phase delay layer, which is arranged in a transmission path of an optical image having a first linear polarization direction and is configured for converting the polarization direction of the optical image from the first linear polarization direction to an elliptical or circular polarization direction;
an imaging lens layer, which is arranged in a transmission path of an optical image having an elliptical or circular polarization direction, wherein the imaging lens has a first optical surface adjacent to the first phase delay plate and a second optical surface opposite to the first optical surface, the first optical surface being a transflective optical surface; wherein the imaging lens is configured for amplifying an optical image passing through the first optical surface;
a second phase delay layer, which is arranged on one side of the second optical surface of the imaging lens and is configured for converting the polarization direction of the optical image from the elliptical or circular polarization direction to the first linear polarization direction; and
a reflective type polarization layer, which is adhered to the second phase delay layer and has a transmission direction orthogonal to the first linear polarization direction;
wherein, the optical image successively passes through the first phase delay layer, the imaging lens layer, the second phase delay layer and the reflective type polarization layer, and the reflective type polarization layer is configured for reflecting an optical image having a first linear polarization direction that is transmitted from the second phase delay layer, the imaging lens layer is configured for reflecting and again amplifying the optical image reflected by the reflective type polarization layer, and the second phase delay layer is further configured for converting the polarization direction of the amplified optical image into a non-first linear polarization direction, thereby passing the optical image having the non-first linear polarization direction through the reflective type polarization layer.
